(19) United States
(12) Patent Application Publication
(10) Pub. No.: US 2011/0247248 A1
(43) Pub. Date: Oct. 13, 2011

(54) VEHICLE ACCESSORY

(75) Inventor: Kieron Dowd, New South Wales (AU)

(73) Assignee: DOWD GROUP PTY LIMITED, West Pennant Hills , New South Wales (AU)

(21) Appl. No.: 13/140,892

(22) PCT Filed: Dec. 18, 2009
(86) PCT No.: PCT/AU09/01660

§ 371 Date: Jun. 22, 2011

(30) Foreign Application Priority Data
Dec. 18, 2008 (AU) 2008906481
Feb. 25, 2009 (AU) 2009900812

(51) Int. Cl. G09F 7/18; B60R 13/10

(52) U.S. Cl. 40/209

(57) ABSTRACT

An attachment for a vehicle number plate includes at least one resilient portion that prevents or limits vibration of the number plate and/or damage to the vehicle by the number plate itself or by the attachment.

### FIELD OF THE INVENTION

The present invention relates to vehicle accessories and in particular to accessories for attachment to the external vehicle surface.

### BACKGROUND OF THE INVENTION

Plastic frames are frequently attached to vehicle number plates, also called license plates. These closely follow the peripheral edge of the number plate and often advertise car dealerships. However, such frames are prone to excessive vibration when the vehicle is driven over uneven surfaces and may also be affected by vibration from the engine and the impact of closing the car boot. This can cause damage where the frame and/or plate vibrate or otherwise impact against the surface of the vehicle.

Recently, frames that incorporate LED displays have also been attached to car number plates and may display scrolling text to display a number of different advertisements. These displays require an electrical supply to power them such as may be provided by the car battery.

It would be advantageous to provide an improved number plate frame or at least to provide a useful alternative.

### SUMMARY OF THE INVENTION

In a first aspect the present invention provides an attachment for a vehicle number plate, the attachment being at least partly formed from a resilient material.

The attachment preferably spaces the vehicle number plate from the vehicle and more preferably spaces the peripheral edge of the vehicle number plate from the vehicle.

Portions of the attachment that may contact the vehicle are preferably formed or a resilient material.

Portions of the attachment that engage the vehicle number plate are preferably resilient.

In one form the vehicle number plate is received in at least one recess in the attachment. The material defining the at least one recess may be resilient. Alternatively a resilient material may be provided in the recess to engage part of the vehicle number plate.

In one form the attachment comprises a length of resilient material with a first slot extending along the length of the material. In use the edge of the vehicle number plate is located in the first slot with the resilient material extending rearwards. In use the resilient material engages the vehicle surface and prevents damage by the vehicle number plate edge. Additionally the resilient material may dampen vibration of the vehicle number plate.

The resilient material may be a continuous loop that engages the edge of the number plate or maybe a sheet like or frame like member.

The attachment may include at least one second engagement portion adapted to receive a cover that in use extends in front of the vehicle number plate.

The resilient material may include at least one cushioning portion.

When the attachment is attached to the plate, at least one cushioning portion may be located behind the vehicle number plate.

At least one cushioning portion may engage at least one of the vehicle number plate and, in use, the vehicle.

The attachment may include at least one engagement portion that engages part of the vehicle number plate.

The at least one engagement portion may engage at least part of the peripheral edge region of the vehicle number plate.

At least one engagement portion may include at least one slot into which at least part of the edge of the vehicle number plate is received.

At least part of at least one slot may be defined by at least one cushioning portion.

The attachment may include a frame that extends around substantially all of the peripheral edge region of the vehicle number plate.

The frame may define a slot or series of slots therein to receive and engage part of or substantially all of the peripheral edge region of the vehicle number plate.

At least part of the frame is preferably resilient. Preferably the frame is under tension when attached to the plate.

At least part of the frame may be rigid.

At least one cushioning portion may be located between the frame and the vehicle number plate.

The attachment may include at least one spacer portion that extends behind the rear of the vehicle number plate.

At least one spacer portion, in use, may provide an air space between the vehicle number plate and the vehicle surface to reduce or prevent moisture buildup between the plate and the vehicle surface

The at least one spacer portion may include a sheet portion that extends behind the vehicle number plate. The sheet may have at least one aperture therein.

The at least one spacer portion may comprise at least one finger extending behind the rear surface.

The air space(s) and/or any aperture(s) may have any shape and more particularly may have a shape selected from the group including: a circle, oval, ellipse, regular polygon, irregular polygon, rhombus, rectangle, square and a diamond.

The spacer may include at least one protrusion extending forwards adapted to be passed through at least one aperture in the vehicle number plate and secured thereto.

The attachment may include a second engagement portion to engage a cover in front of the vehicle number plate.

The attachment may be mounted to the vehicle and the vehicle number plate attached to the attachment.

The entire attachment may be formed or resilient materials, with any cushioning portion(s) and any engagement portion(s) being formed of the same or different resilient material.

The spacer, cushioning portion and engagement portions are not mutually exclusive and a single part of the attachment may be a spacer, a cushioning portion and/or an engagement portion

The resiliently deformable material may prevent damage to the vehicle surface by the number plate and/or the frame when the frame is mounted to the plate.

The resiliently deformable material may be stretched to fit tightly around a number plate for mounting to the plate.

The resiliently deformable material may reduce vibration of the plate and associated noise and/or damage to the vehicle surface.

The attachment may include a display surface adapted to display text and/or images.

The display surface may be at least partly formed from a resiliently deformable material.

The display surface may include or carry an advertisement. The display surface may have a shape at least partly defined by at least part of an item selected from the group including: a circle, oval, ellipse, regular polygon, irregular polygon, rhombus, rectangle, square, diamond, a representation of sports equipment, a map, a representation of a country or region, a representation of a life form, including an animal or plant, whether real or imaginary, the outline of a picture, image or graphical element and text.

The resiliently deformable material may be selected from a resiliently deformable polymer, rubber, plastic and combinations thereof.

The resiliently deformable material may be a silicon-based material.

The resiliently deformable material may be a rubber, including silicon rubber.

The attachment may include one or more portions that are luminous.

The luminous portion(s) may be formed of a phosphorescent material.

The attachment may be integrally formed.

The attachment may include non deformable material.

The non deformable material may be selected from plastic, rubber, metal, glass, wood, composites and combinations thereof.

In a second aspect the present invention provides an attachment for a vehicle number plate said attachment being at least partly formed from a luminous material.

The luminous material may be a phosphorescent material.

The attachment may further include a display surface adapted to display text and/or images.

The display surface may include or carry an advertisement.

Any discussion of documents, acts, materials, devices, articles or the like which has been included in this specification is solely for the purpose of providing a context for the present invention. It is not to be taken as an admission that any or all of these matters form part of the prior art base or were common general knowledge in the field relevant to the present invention as it existed in Australia or elsewhere before the priority date of this application.

Throughout this specification the word “comprise”, or variations thereof such as “comprises” or “comprising”, will be understood to imply the inclusion of a stated element integer or step, or group of elements, integers or steps, but not the exclusion of any other element, integer or step, or group of elements, integers or steps.

The features and advantages of the present invention will become further apparent from the following detailed description of preferred embodiments, provided by way of example only, together with the accompanying drawings.

### BRIEF DESCRIPTION OF THE ACCOMPANYING DRAWINGS

Embodiments of the present invention will now be described, by way of example only, with reference to the accompanying drawings in which:

FIG. 1 shows five views of a number plate frame according to the invention illustrating (A) a front perspective view of a frame, (B) a front view of the frame mounted to a number plate, (C) a rear view of the frame; (D) a bottom view of the frame, and (E) a cross sectional view of the frame alone taken along line AA of FIG. 1B;

FIGS. 2-4 illustrate a selection of frames according to the invention showing various shapes and designs for display surfaces;

FIG. 5 shows a frame according to the invention comprising luminous material;

FIG. 6 shows a rear view of an attachment for a number plate according to another embodiment of the invention;

FIG. 7 shows a view of the bottom of the FIG. 6 embodiment;

FIG. 8 shows a view of the front of the FIG. 6 embodiment;

FIG. 9 shows a cross sectional view of the FIG. 6 embodiment taken along line AA of FIG. 8;

FIG. 10 shows a detail view the part labeled B in FIG. 9;

FIG. 11 shows a perspective view of another embodiment of the invention;

FIG. 12 shows a cross sectional view of the embodiment of FIG. 11;

FIG. 13 shows a perspective view of another embodiment of the invention;

FIG. 14 shows a side view of the embodiment of FIG. 13;

FIG. 15 shows perspective view of a portion of another embodiment of the invention;

FIG. 16 shows a plan view of the embodiment of FIG. 15 attached to a number plate;

FIG. 17 shows a cross sectional view of the embodiment of FIG. 15 when attached to a number plate;

FIG. 18 shows a cross sectional; view of another embodiment of the invention;

FIG. 19 shows a cross sectional; view of another embodiment of the invention;

FIG. 20 shows a cross-sectional view of the embodiment of FIG. 20, and FIG. 21 shows a rear view of a backing sheet with alternate configurations.

### DETAILED DESCRIPTION OF EXEMPLARY EMBODIMENTS OF THE INVENTION

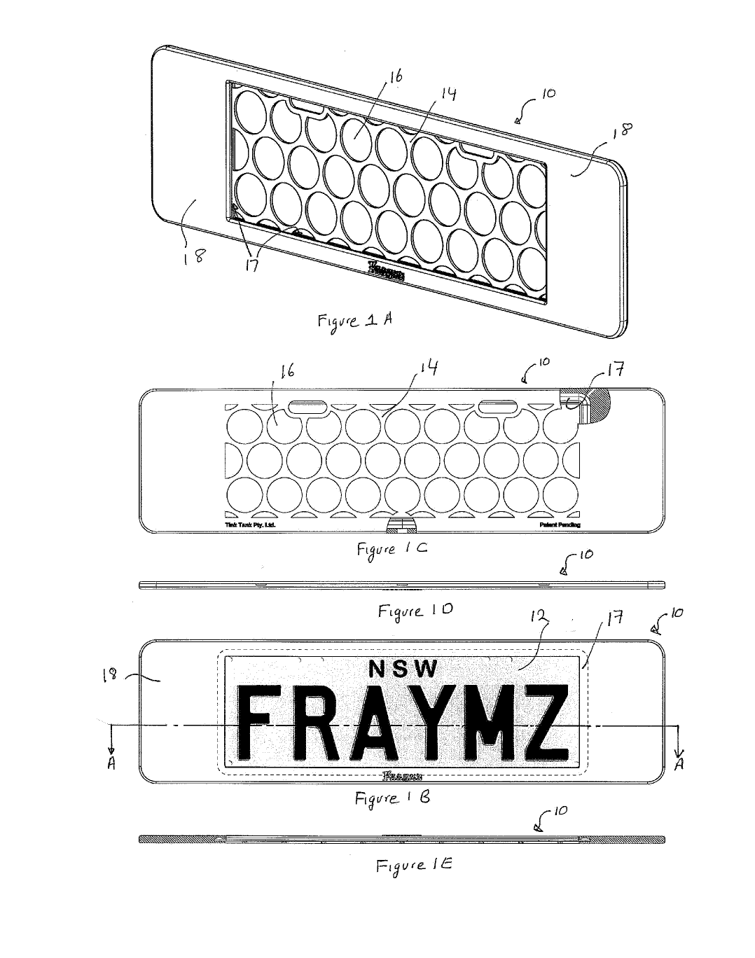

Referring to FIG. 1(A-E) there is illustrated a frame 10 for attachment to a vehicle number plate 12. The frame has a slot 17 into which the edge of the number plate is received. The frame is integrally formed from a resiliently deformable material in the form of silicone rubber. The resiliently deformable rubber allows the frame to be stretched to fit tightly around a number plate for mounting to the plate as shown in FIG. 1B,

In use, the number plate is removed from the vehicle and placed into the frame which is stretched to fit around the plate. The plate is then reattached to the vehicle while remaining within the frame, thus mounting both plate and frame to the vehicle.

The illustrated frame of FIG. 1 includes a silicone rubber cushioning portion 14 which is integrally formed with the frame. The cushioning portion is located at the back of the frame and lies between the plate and the vehicle surface when the frame and plate are mounted to the vehicle. The cushioning portion includes a number of holes 16 that act to reduce or prevent moisture build-up between the plate and the vehicle surface and/or facilitate stretching of the frame for mounting to the plate.

The relatively soft resiliently deformable material of the frame acts to prevent damage to the vehicle surface by the number plate and/or the frame, in particular by preventing or reducing vibration or impact of the plate and/or frame against the vehicle surface. This has the added advantage of preventing or reducing the generation of noise associated with vibration of the frame and/or the plate.

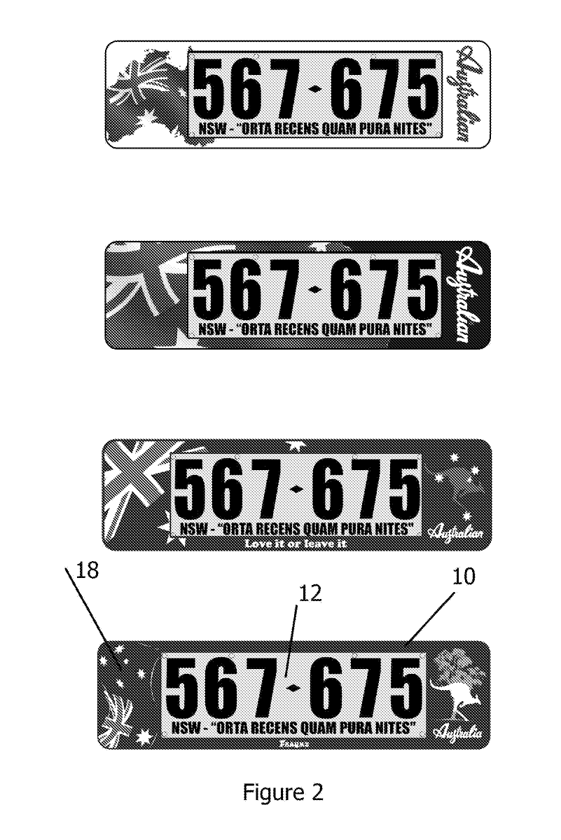

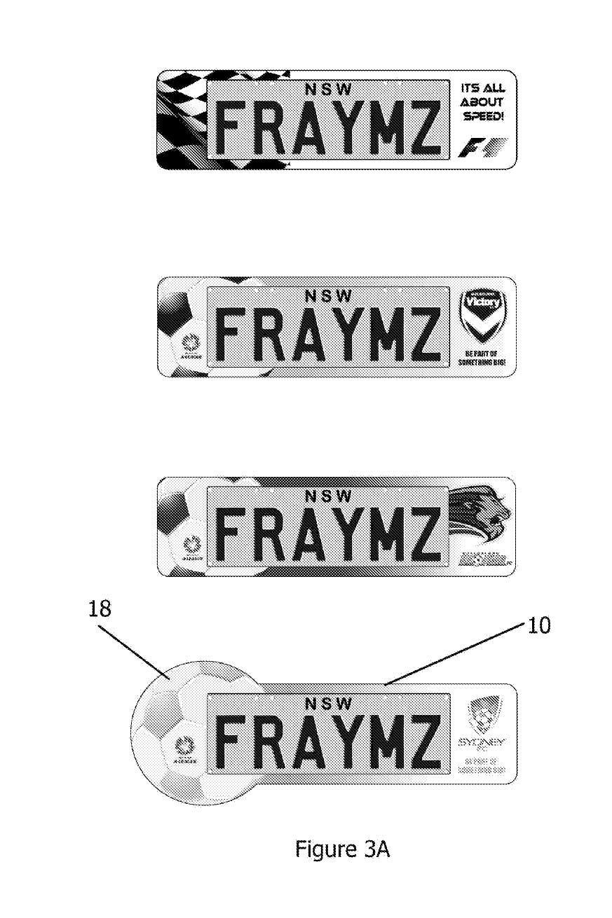

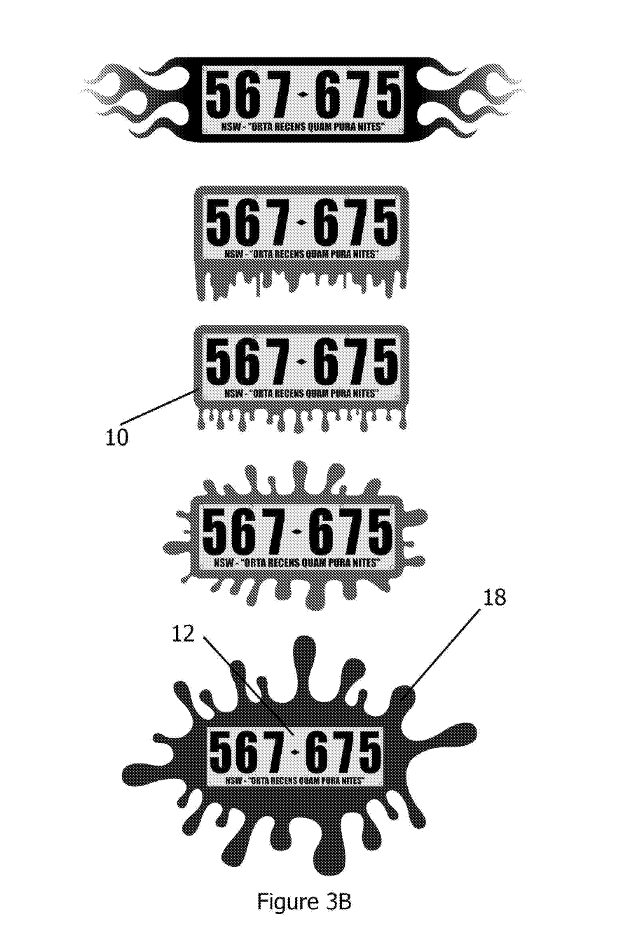

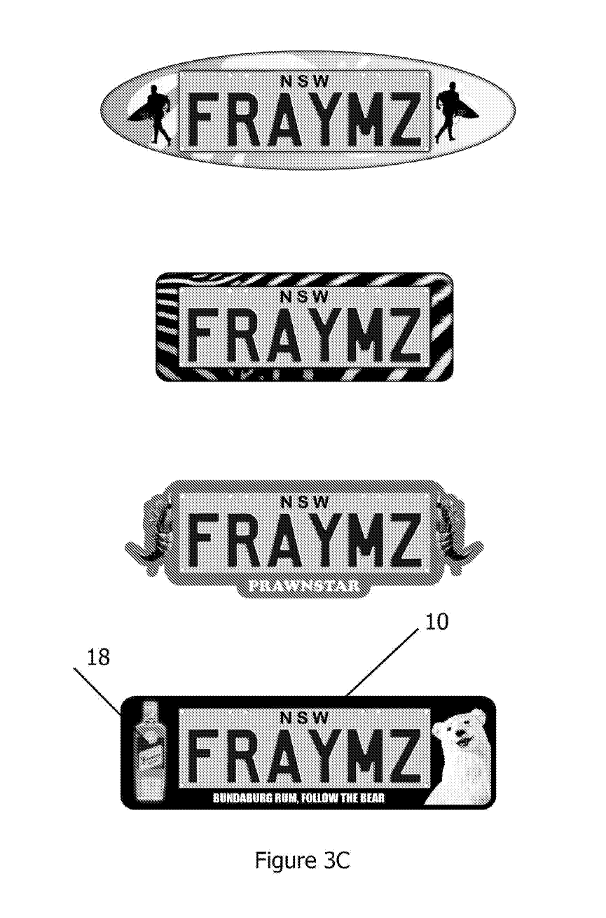

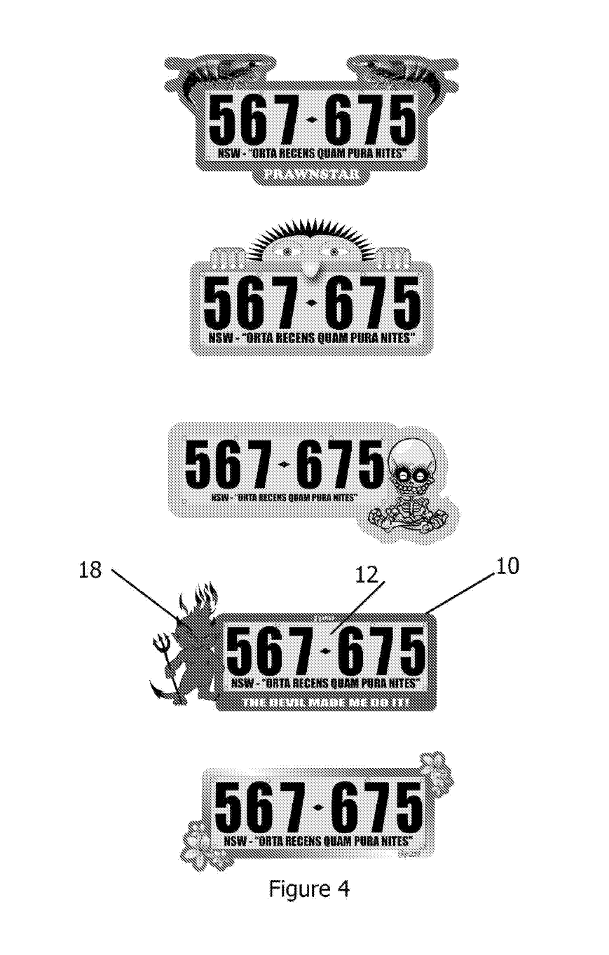

The illustrated frame of FIG. 1 also includes an integrally formed resiliently deformable display surface 18 adapted to display text and/or images. Further examples of frames according to the invention are shown in FIGS. 2-4. While some of the illustrated display surfaces show advertisements, others simply provide an aesthetically pleasing display. The resiliently deformable material of the frame and display surface act to absorb vibrations, which helps to reduce or prevent breakage of the frame/display surface. This provides additional durability allowing the frame/display surface to be extended beyond the immediate border of the plate as shown. The resiliently deformable material may also be configured to conform to the external surface of the vehicle for a tighter and/or more stable fit. In some embodiments, the frame may also include luminous material, such as phosphorescent material for an increased visual effect in low light conditions.

While silicone rubber may be used to construct a frame, it will also be appreciated that other resiliently deformable materials, such as resiliently deformable polymers, rubbers and plastics, may be used, for example polyurethane, PVC and various elastomers. Where plastic and rubber are used concurrently in a given frame, these may be co-extruded.

Alternatively, the resiliently deformable component of the frame may form only part of the frame, such that other parts of the frame may be formed from other materials such as plastic, rubber, metal, glass, wood and composites such as fiberglass and carbon fiber reinforced plastic for example.

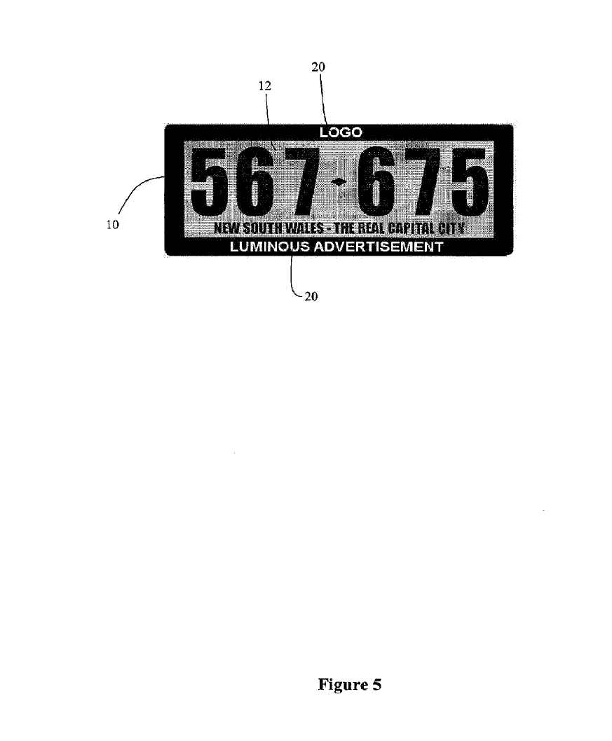

Referring to FIG. 5, there is illustrated an alternative embodiment where the frame 10 includes a phosphorescent “glow in the dark” material 20. The illustrated frame is of a regular size and shape and may or may not include any resiliently deformable material. Accordingly, the shape and material used may be that of a conventional frame but where the frame incorporates phosphorescent “glow in the dark” material to display text and/or graphics, such as advertisements, in the absence or lack of light and without the need for a power source to illuminate the display. While the illustrated frame has a generally dark border with luminous text displayed, other frames may comprise a luminous border with dark, text displayed thereon, i.e. where the text does not glow in the dark, thus providing a ‘silhouette effect’.

FIGS. 6 to 10 show a number plate vehicle protector 30 similar to that of FIG. 1 but lacking the display areas 18. The protector 30 is preferably formed integrally of a resilient and deformable material, such as silicon rubber and has a peripheral frame 32 and a rear backing member 34. The backing member 34 is, in effect, a continuous sheet extending between the frame 32 with a series of holes 36 passing through the sheet. These holes 36 are generally circular or part circular but may be other shapes, such as oval holes 38. As with the FIG. 1 embodiment the holes 36 aid in mounting of the protector on a number plate and in prevention or reduction of moisture buildup or retention. The holes 36 may be omitted. The backing member in the FIG. 5 embodiment need not be a continuous sheet and could, for example, be formed from one or more inwardly extending flanges or fingers. These fingers may extend part way or fully across the frame.

Referring to FIG. 10 the frame 32 is formed by a forward arm 40 that extends inwards from the front peripheral edge of the backing member 34 to define a slot 46. The slot 46 is sized to engage the peripheral edge of the number plate. Many number plates have a pressed rim and so the main part of the slot 46 is thicker than the opening 44 to accommodate this rim. For rimmed number plated the narrow opening aids in retention of the frame on the number plate. This expansion of the slot 46 is not essential and if desired a simple rectangular slot may be provided. This may be the size of the opening 44 for use with rimless number plates or wider, to accommodate rimed number plates.

The bottom arm 50 of the frame 32 is provided with one or more openings 52 that allow water that enters the slot 46 to escape.

In use the protector is mounted on the number plate and the number plate is then secured to the vehicle, sandwiching the backing member 34 between the vehicle and number plate. The nature of the silicon rubber allows the number plate to be held firmly against the vehicle, with the protector surrounding the peripheral edges of the number plate and preventing any vibration of the number plate from damaging the surface of the vehicle. The backing member 34 spaces the number plate from the vehicle and so prevents the “central” regions of the number plate contacting the vehicle, even if the number plate bent from minor damage.

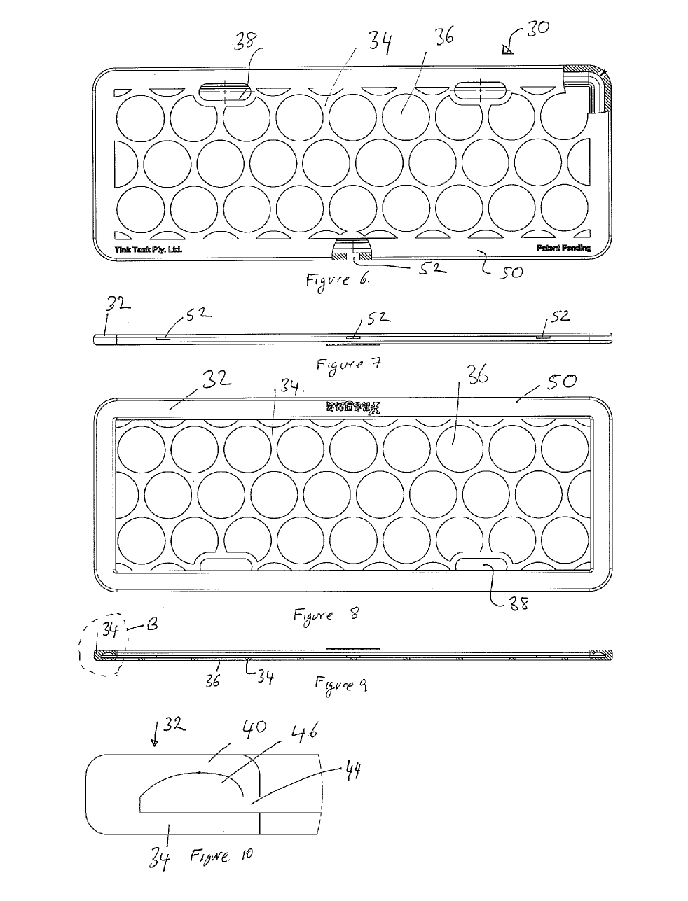

FIGS. 11 and 12 show a protector 60 that is a variation of the protector of FIGS. 6 to 10. The protector has a frame 62 and an integrally formed spacer 64. As with the previous embodiment the spacer is sheet like with a series of apertures 66. As best seen in FIG. 12 the frame 62 has a first slot 68 for receiving the peripheral edge of a number plate 74. This slot 68 has a ridge 72 that extends along the slot and serves to aid retention of a rimmed number plate. The ridge 72 may be continuous or a series of protrusions extending along the length of the slot. Each protrusion may be circular or rectangular, extending along the length of the slot. The corresponding slots of the FIGS. 1 to 10 embodiments may be provides with one or more similar protrusion(s).

The upper arm of the frame is thicker than in the previous embodiment and has a second slot 70 that is sized to receive a clear protective sheet 76, usually formed of a polymer, such as Poly(methyl methacrylate) (sold under various brand names, including Perspex) or polycarbonates. In use the protector is mounted on the number plate 74, the number plate 74 and protector 60 are then mounted on the vehicle 80 using fasteners 78 and the protective sheet is mounted in the slot 66. The resilience of the frame allows the frame to be deformed to allow the protective sheet 76 to be positioned in the slot and to then return to the position shown.

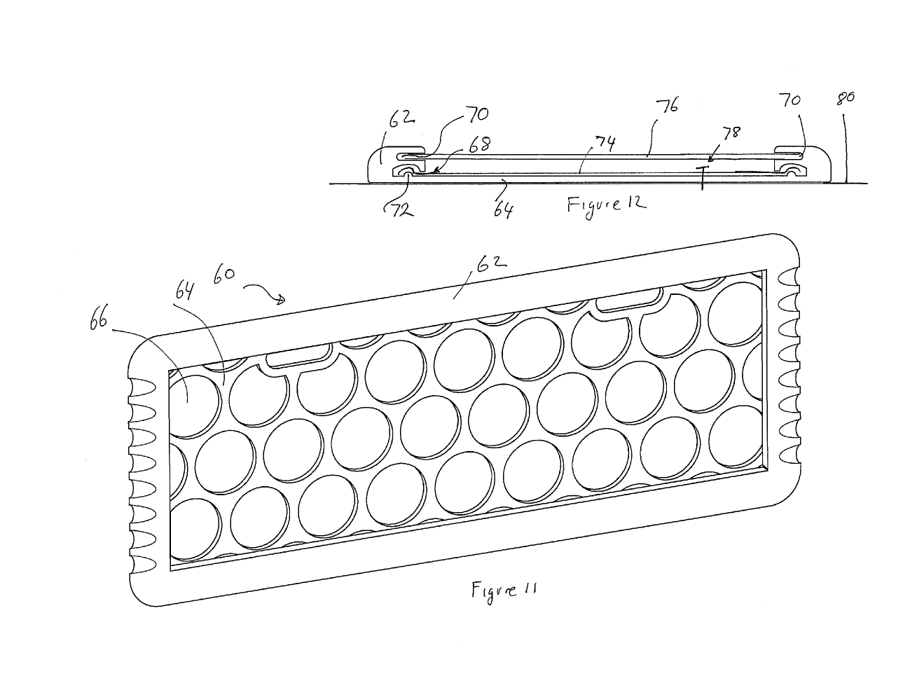

A protector 80 according to another embodiment of the invention is shown in FIGS. 13 and 14. The protector 80 includes a rear sheet 82, optionally provided with apertures 84 for moisture removal purposes as previously described. The rear sheet 82 has a number of protrusions 86, each of which has a post 88 extending from the sheet with a head 90 at the free end of the post 88. The protrusions are located to match corresponding apertures 92 in the number plate 94. The heads are larger than the apertures 92 but may be deformed to pass through.

In use the protector 80 is positioned to the rear of the number plate 94 and the number plate 94 pushed against the protector 80 to force the protrusions 86 through the corresponding apertures 92.

The posts 88 are preferably a snug fit in the apertures 92. The length of the posts 88 may be such that when the number plate 94 is mounted on the protector 80 the posts 88 are slightly stretched, so snugly retaining the number plate 94 against the backing sheet 82.

The backing sheet 82 is oversized compared to the number plate and so extends beyond the peripheral edge 96 of the number plate. Thus the number plate cannot contact the surface of the vehicle and cause any damage.

The protector is optionally provided with a peripheral ridge 98 that extends adjacent to the edge of the sheet.

In use the number plate is first mounted on the protector and the assembly is then mounted on the vehicle by passing fasteners through the number plate into the vehicle.

Although the embodiment described utilizes fasteners that pass through the number plate to fasten the assembly to the vehicle it is within the scope of the invention for the protector to be provided with means to enable the protector to be mounted to the vehicle before mounting of the number plate to the protector. The mounting means may be apertures into which suitable fasteners may pass to secure the protector to the vehicle. The number plate is then be secured to the protector. This may require a deeper slot or stiffer material for at least the slot portion to prevent accidental dislodgement of the number plate but the fasteners would be hidden. If desired additional fasteners may pass through both the number plate and protector as additional security, preferably located unobtrusively.

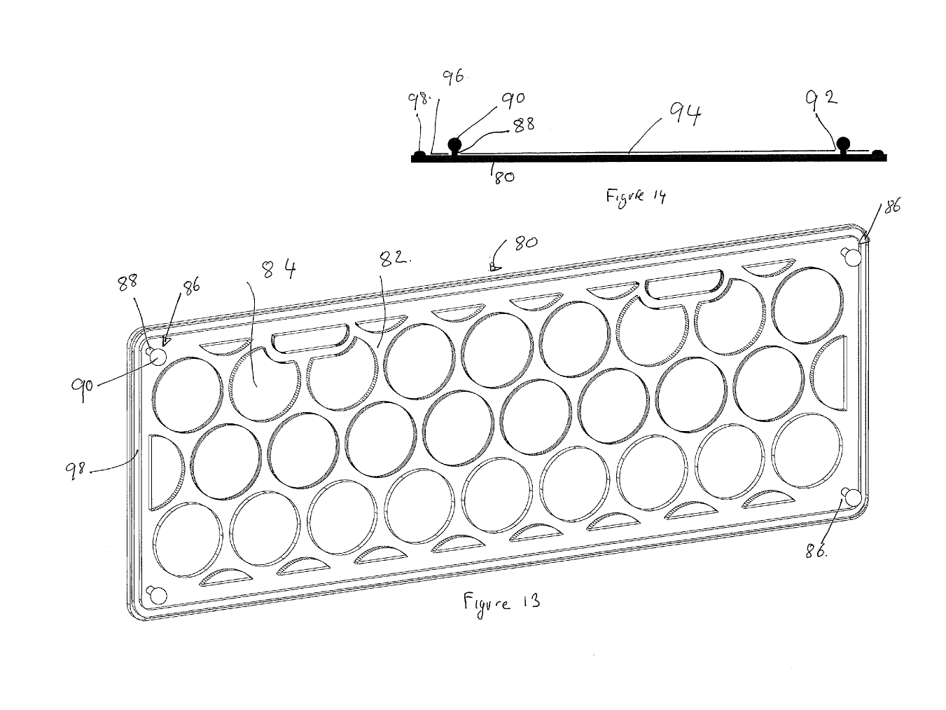

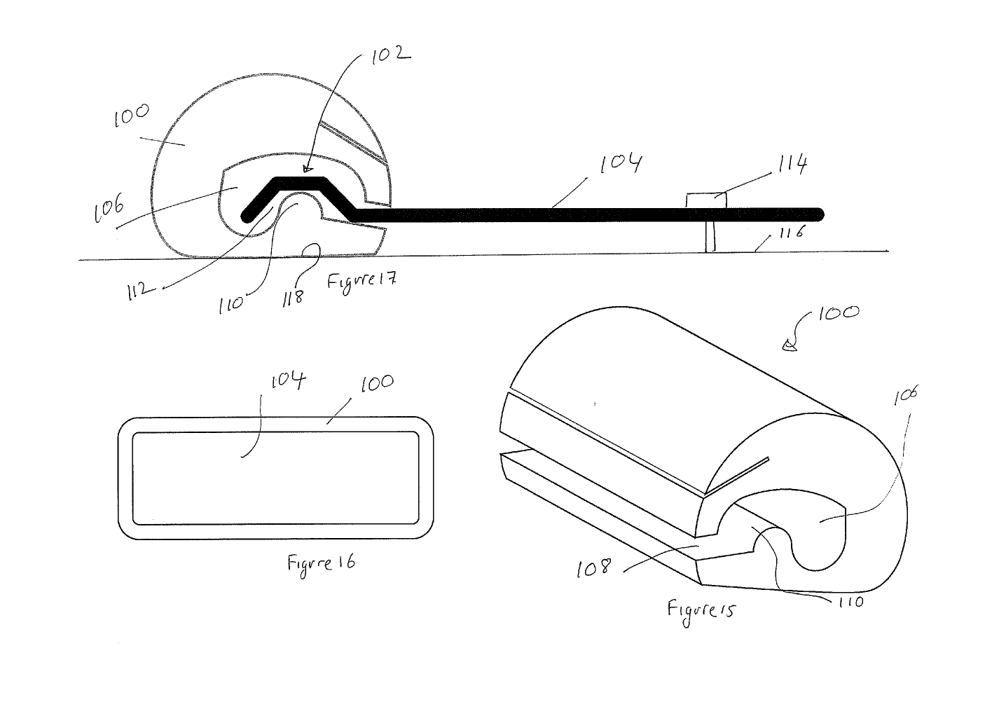

FIGS. 15 to 17 show an edge protector 100 according to a further embodiment of the invention. The edge protector 100 is a rectangular loop sized to engage the peripheral edge 102 of a number plate 104. The protector has an inwards facing slot 106 into which the edge of the number plate slides. The material of the protector is resilient, preferably silicon rubber or the like, and so the protector may be stretched to fit onto the number plate. The slot 106 is formed with a narrow entrance 108 and a longitudinally extending protrusion 110 to engage the underside of a peripheral groove 112 on the number plate 104. As with the embodiment of FIGS. 11 and 12, a single continuous protrusion or a series of separate protrusions may be provided. If desired the protrusion(s) may be omitted. The loop is preferably continuous and sized so that when placed on the number plate the loop is under a small amount of tension, so keeping the loop snugly on the number plate.

The protector 100 wraps around the peripheral edge of the number plate and so prevents damage to the vehicle by the edge. The number plate is fastened to the vehicle by separate fasteners 114 and preferably these fasteners cause the number plate to snugly sandwich the base 118 of the protector 100 against the vehicle surface 116, so aiding in preventing or minimizing vibration of the number plate. Even if not so sandwiched the nature of the material used will tend to dampen vibration of the number plate.

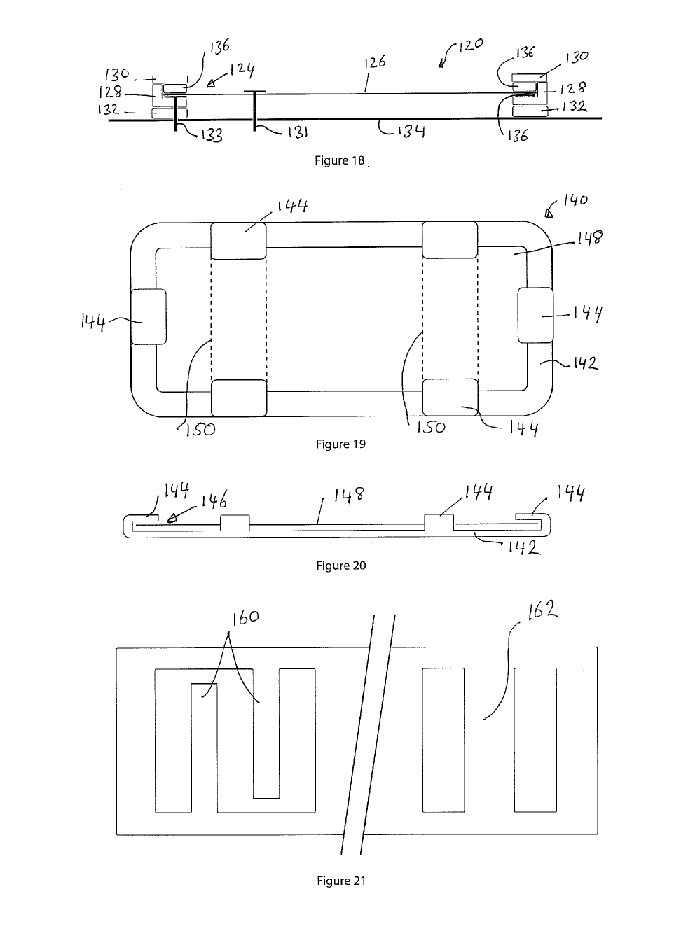

FIG. 18 shows a protector 120 that comprises a rigid frame 122 having a slot 124 for receiving the periphery of a number plate 126. Being rigid the frame 122 cannot be deflected to mount on the number plate and accordingly is formed of two pieces 128, 130 that are joined together. This can be by a snap fit or fasteners or adhesive may be used.

The rear portion 128 is preferably provided with resilient and deformable cushion 132 on its rear, which sits between the frame 122 and the surface of the vehicle 134. Preferably the cushioning means 132 is under compression and so tends to prevent or minimize vibration of the frame 122 and so prevents or minimizes damage caused by such movement. The frame 120 is also preferably provided with slot mounted cushioning 136. The slot mounted cushioning 136 is preferably located in the slot either side of the number plate and snugly engages the number plate, so preventing or minimizing vibration of the number plate relative to the frame. If desired the slot mounted cushioning may be provided on only one side of the number plate, so as to sandwich the number plate between itself and the rigid frame.

The number plate may be fastened to the vehicle via fasteners 131 that engage the number plate or via fasteners 133 that engage the rear portion 128.

In another unshown embodiment a frame may be provided with only one of the cushioning 132 and 136.

The cushioning 132 and 136 may be continuous around the frame or the slot or may be discontinuous. The cushioning may be any suitable resilient material. Examples include silicon rubber and closed cell foams.

The frame need not engage the vehicle number plate continuously along its edge and may engage the vehicle number plate at separate locations.

FIGS. 19 and 20 show an attachment having base 142 with a series of mountings 144 that engage the edges of the vehicle number plate 148. Each mounting 144 has a slot 146 into which the number plate 148 is snugly received. The base and mountings are preferably formed of a resilient material, such as silicon rubber and so may be deflected to mount on the number plate. By providing the material with sufficient stiffness the number plate is held securely in the attachment.

The base may be rigid with the mountings being resilient themselves or may be rigid with a resilient base resilient. In addition cushioning portions may be provided within the slots 146.

The base 142 may be provided in a substantially clear material, in which case the base 142 may extend across the front of the number plate, with the mountings 144 behind the number plate and sandwiched between the number plate and the vehicle.

Optionally, opposed mountings may extend across the number plate to form a strap, as shown in dotted outline at 150.

FIG. 21 shows alternate arrangements of back portions for use with the embodiments that utilize a backing sheet. Instead of a sheet with a series of apertures the back portion may comprise one or more fingers 160 that extend part way across the number plate. These fingers may extend from either side of the attachment, as shown, or only one side. Alternatively, there may be one or more fingers 162 that extend fully across the number plate.

It can be seen that embodiments of the invention have at least one of the following advantages:
prevented or reduced damage to the vehicle surface;
improved durability of the frame allowing for a larger display surface;
conformity of the frame, and in particular the display surface, to the vehicle surface;
integral formation of the frame for ease of manufacture;
the display of text and/or graphics, such as advertisements, in the absence or lack of lighting; and
the display of text and/or graphics without the need for a battery power source.

It will be appreciated by persons skilled in the art that numerous variations and/or modifications can be made to the invention as shown in the specific embodiments without departing from the invention as broadly described. The present embodiments are, therefore, to be considered in all respects as illustrative and not restrictive.

The invention that may be claimed may include the following novel arrangements, either singularly or in any combination thereof:

1. An attachment for a vehicle number plate said attachment being at least partly formed from a resilient material.

2. The attachment of claim 1 wherein said resilient material includes at least one cushioning portion.

3. The attachment of claim 2, wherein, when the attachment is attached to the plate, at least one cushioning portion is located behind the vehicle number plate.

4. The attachment of claim 1 wherein at least one cushioning portion engages at least one of the vehicle number plate and, in use, the vehicle.

5. The attachment of claim 1 including at least one engagement portion that engages part of the vehicle number plate.

6. The attachment of claim 5 wherein at least one engagement portion engages at least part of the peripheral edge region of the vehicle number plate.

7. The attachment of claim 5 wherein the at least one engagement portion includes at least one slot into which at least part of the edge of the vehicle number plate is received.

8. The attachment of claim 7, wherein at least part of the at least one slot is defined by at least one cushioning portion.

9. The attachment of claim 1 including a frame that extends around substantially all of the peripheral edge region of the vehicle number plate.

10. The attachment of claim 9 wherein said frame defines a slot therein to receive and engage substantially all of the peripheral edge region of the vehicle number plate.

11. The attachment of claim 9 wherein at least part of the frame is resilient.

12. The attachment of claim 10, wherein said frame is under tension when attached to the plate.

13. The attachment of claim 9 wherein the at least part of the frame is rigid.

14. The attachment of claim 9, wherein at least one cushioning portion is located between the frame and the vehicle number plate.

15. The attachment of claim 1 including at least one spacer portion that extends behind the rear of the vehicle number plate.

16. The attachment of claim 15, wherein at least one spacer portion, in use, provides an air space between the vehicle number plate and the vehicle surface to reduce or prevent moisture buildup between the plate and the vehicle surface.

17. The attachment of claim 15, wherein the at least one spacer portion includes a sheet portion that extends behind the vehicle number plate.

18. The attachment of claim 17, wherein the sheet has at least one aperture therein.

19. The attachment of claim 18 wherein at least one aperture has a shape selected from the group including: a circle, oval, ellipse, regular polygon, irregular polygon, rhombus, rectangle, square and a diamond.

20. The attachment of claim 15 wherein at least one spacer portion comprises at least one finger extending behind the rear surface.

21.-38. (canceled)

39. (canceled)
